(19) United States
(12) Patent Application Publication
(10) Pub. No.: US 2008/0210497 A1
(43) Pub. Date: Sep. 4, 2008

(54) BRAKE SYSTEM FOR HYBRID ELECTRIC VEHICLE AND CONTROL METHOD THEREOF

(76) Inventor: Gab Bae JEON, Gunpo-si (KR)

Correspondence Address: MORGAN, LEWIS & BOCKIUS LLP (SF), One Market, Spear Street Tower, Suite 2800, San Francisco, CA, 94105, US

(21) Appl. No.: 11/829,688

(22) Filed: Jul. 27, 2007

(30) Foreign Application Priority Data
Aug. 1, 2006 (KR) 10-2006-0072604

(51) Int. Cl. F16D 55/224; G06F 19/00

(52) U.S. Cl. 188/72.1; 701/22; 903/947

(57) ABSTRACT

The present invention provides a brake system and its control method for a hybrid electric vehicle, comprising a driving motor generating a regenerative braking torque; a hydraulic pressure supplying unit including a brake pedal, a booster and a master cylinder, a first hydraulic line, and a reservoir; a hydraulic brake adjuster for controlling a hydraulic braking pressure; a target braking force detection unit, including a pedal stroke sensor and a hydraulic pressure sensor, for detecting a target braking torque of a driver; and a control unit controlling the driving motor by calculating a maximum regenerative braking torque based on a rotational speed of the driving motor, etc. and controlling the hydraulic brake adjuster to change a hydraulic braking torque to meet the target braking torque in accordance with the thus calculated maximum regenerative braking torque by compensating an braking torque with the hydraulic braking torque.

### CROSS-REFERENCE TO RELATED APPLICATION

This application claims under 35 U.S.C. §119(a) on Korean Patent Application No. 10-2006-0072604 filed on Aug. 1, 2006, the entire contents of which are incorporated herein by reference.

### BACKGROUND OF THE INVENTION

(a) Field of the Invention

The present invention relates to a brake system for a hybrid electric vehicle and a control method thereof and more particularly to a brake system and a control method of incorporating a hydraulic braking system used in gasoline and diesel vehicles into a regenerative braking system, thus obtaining the target braking torque through a cooperative control of the regenerative braking system and the hydraulic braking system.

(b) Background Art

A hybrid electric vehicle is a next generation environment-friendly vehicle in which a combustion engine and a driving motor driven by electrical energy stored in a battery are simultaneously assembled.

When stopping the driving motor in such a hybrid electric vehicle, especially, when pressing a brake pedal, a regenerative braking torque is generated by reversing the polarity of electric power applied to the driving motor.

That is, if a driver presses the brake pedal while driving the hybrid electrical vehicle, the power supplied to the driving motor is cut, and a counter electromotive torque generated in a power terminal of the driving motor rotated by an inertial force of a running vehicle is applied to the driving motor so as to generate a torque in the direction opposite to the running direction, thus generating a braking force, which is called a “regenerative braking force”.

In such a conventional hybrid electric vehicle, since a hydraulic brake system is not used, a brake hydraulic pressure is controlled using an electro-hydraulic brake (hereinafter referred to as EHB) system comprising a pedal simulator instead of a booster and an actuator generating the brake hydraulic pressure.

However, an effort of the brake pedal pressed by a driver is not transmitted to respective wheel cylinder hydraulic pressures, and a brake hydraulic pressure is generated by an electrical operation of the EHB system. Accordingly, the EHB system has a problem in that it may cause an electric malfunction at any time and thereby a desired braking force cannot be obtained during such an electric malfunction.

Moreover, the EHB system has another problem in that a separate pedal simulator is required to obtain the same pedal feel as the existing hydraulic braking system through the EHB system, and thereby development time and cost for the pedal simulator are increased.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

The present invention has been made in an effort to solve the above problems and to provide a brake system for a hybrid electric vehicle and a control method thereof that incorporate a hydraulic braking system used in gasoline and diesel vehicles to a regenerative braking system, thus obtaining the target braking torque through a cooperative control of the regenerative braking system and the hydraulic braking system.

In one aspect, the present invention provides a brake system for a hybrid electric vehicle comprising a regenerative braking system, a hydraulic braking system, a target braking force detection unit, and a control unit.

The regenerative braking system includes a driving motor generating a regenerative braking torque.

The hydraulic braking system includes a hydraulic pressure supplying unit and a hydraulic brake adjuster. The hydraulic pressure supplying unit comprises a brake pedal, a booster and a master cylinder that increase an effort of the brake pedal, a first hydraulic line of front and rear wheel sides, and a reservoir storing brake oil to be supplied to the first hydraulic line. The hydraulic brake adjuster includes a hydraulic pump for increasing or reducing a hydraulic braking pressure supplied from the hydraulic pressure supplying unit to wheel cylinders and a hydraulic pressure sensor to detect the hydraulic braking torque transmitted to the wheel cylinders.

The target braking force detection unit includes a pedal stroke sensor detecting a stroke of the brake pedal to detect a target braking force of a driver and a hydraulic pressure sensor detecting a hydraulic pressure of the master cylinder.

The control unit controls the driving motor by calculating a maximum regenerative braking torque in accordance with a rotational speed of the driving motor, etc. and regulates the hydraulic brake adjuster to change a hydraulic braking torque to meet the target braking torque based on the thus calculated maximum regenerative braking torque.

In a preferred embodiment, the hydraulic brake adjuster includes a hydraulic pump for pumping the brake oil in the reservoir, and the control unit drives the hydraulic pump to supply the brake oil in the reservoir to the wheel cylinders so as to increase the hydraulic braking torque, if the maximum regenerative braking torque is so reduced that the total braking torque of hydraulic braking torque and the maximum regenerative braking torque goes below the target braking torque.

In another preferred embodiment, the control unit stops the hydraulic pump of the hydraulic brake adjuster to return the brake oil in the wheel cylinders to the reservoir so as to reduce the hydraulic braking torque, if the maximum regenerative braking torque is so increased that the total braking torque of hydraulic braking torque and the maximum regenerative braking torque goes beyond the target braking torque.

Preferably, the hydraulic brake adjuster further includes a first solenoid valve, a second solenoid valve, a third solenoid valve and a fourth solenoid valve. The control unit opens only the first solenoid valve and the third solenoid valve to form a second hydraulic line between the reservoir and the wheel cylinders and operates the hydraulic pump to provide hydraulic braking pressure to wheel cylinders. The control unit opens only the second solenoid valve and the third solenoid valve to form a third hydraulic line so as to decrease hydraulic pressures of the wheel cylinders by draining back the brake oil to the reservoir.

Suitably, the brake system for a hybrid electric vehicle of the present invention further comprises a booster negative pressure supplying unit for supplying a negative pressure to the booster when the engine is not operated.

Moreover, the booster negative pressure supplying unit includes a vacuum pressure sensor detecting vacuum pressure of the booster and a vacuum pump controlled by the control unit based on a signal of the vacuum pressure sensor.

Furthermore, the booster negative pressure supplying unit includes a vacuum tank having a predetermined volume to prevent the negative pressure in the booster from being rapidly reduced during driver's repeated braking.

In another aspect, the present invention provides a control method of a brake system for a hybrid electric vehicle comprising the steps of: determining a target braking torque based on signals detected by a pedal stroke sensor and a hydraulic pressure sensor; distributing the target braking torque to respective wheel cylinders of front and rear wheel sides; calculating a maximum value of a regenerative braking torque based on a rotational speed of a driving motor, a state of charge of a battery, a vehicle state, etc.; determining a current hydraulic braking torque; calculating a hydraulic braking torque to meet the target braking torque based on the maximum regenerative braking torque and the current hydraulic braking torque; and driving a driving motor and controlling a hydraulic brake adjuster, respectively, to generate the thus calculated maximum regenerative braking torque and hydraulic braking torque.

Preferably, the control method of the present invention further comprises the step of driving a hydraulic pump of the hydraulic brake adjuster to supply brake oil from a reservoir to the wheel cylinders, thus increasing the hydraulic braking torque, if the maximum regenerative braking torque is so reduced that the total braking torque of hydraulic braking torque and maximum regenerative braking torque goes below the target braking torque.

Suitably, the control method of the present invention further comprises the step of stopping the hydraulic pump of the hydraulic brake adjuster to return the brake oil from the wheel cylinders to the reservoir, thus reducing the hydraulic braking torque, if the maximum regenerative braking torque is so increased that the total braking torque of hydraulic braking torque and maximum regenerative braking torque goes beyond the target braking torque.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like. The present systems will be particularly useful with a wide variety of motor vehicles.

The above features and advantages of the present invention will be apparent from or are set forth in more detail in the accompanying drawings, which are incorporated in and form a part of this specification, and the following Detailed Description of the Invention, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram showing a brake system for a hybrid electric vehicle in accordance with the present invention;

FIG. 2 is a configuration diagram illustrating a principle in which braking operation is made only by a hydraulic braking force of driver, not by hydraulic pump when a regenerative braking torque is not generated in the brake system of FIG. 1;

FIG. 3 is a configuration diagram illustrating a principle in which the hydraulic braking pressure is increased by hydraulic pump when the maximum regenerative braking torque is so reduced in the brake system of FIG. 1, that the total braking torque of hydraulic braking torque and the maximum regenerative braking torque goes below the target braking torque;

FIG. 4 is a configuration diagram illustrating a principle in which the hydraulic braking pressure is reduced when the maximum regenerative braking torque is so increased in the brake system of FIG. 1 that the total braking torque of hydraulic braking torque and the maximum regenerative braking torque goes beyond the target braking torque; and

FIG. 5 is a control flowchart of a brake system in accordance with the present invention.

It should be understood that: the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present inventions, examples of which are illustrated in the accompanying drawings and described below. While the inventions will be described in conjunction with exemplary embodiments, it will be understood that present description is not intended to limit the inventions to those exemplary embodiments. On the contrary, the inventions are intended to cover not only the exemplary embodiments, but also various alternatives, modifications, equivalents and other embodiments, which may be included within the spirit and scope of the invention as defined by the appended claims.

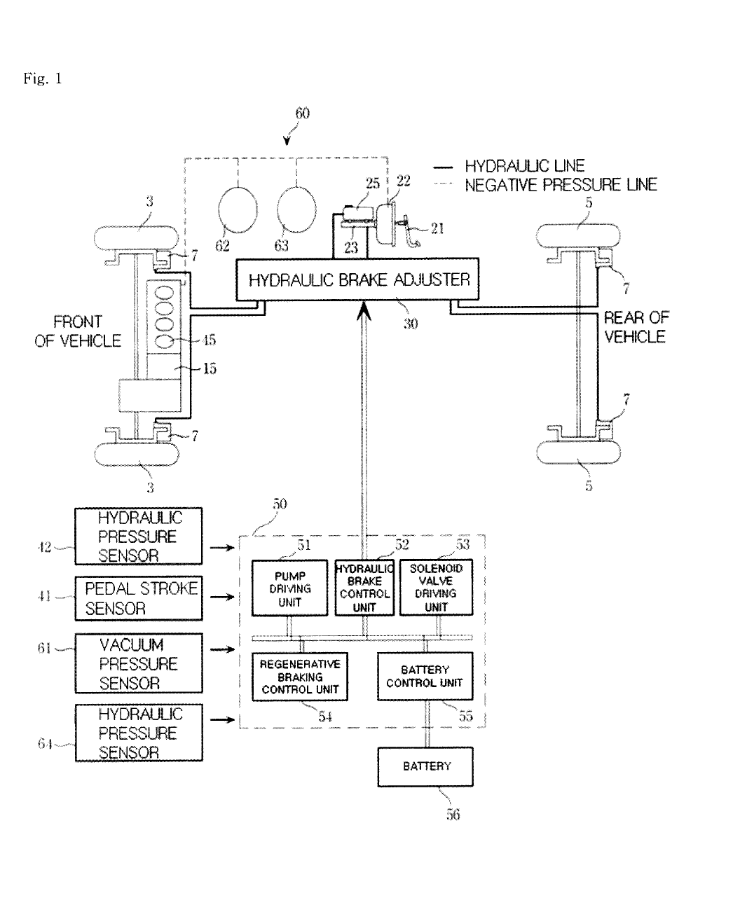

FIG. 1 is a schematic diagram showing a brake system for a hybrid electric vehicle in accordance with the present invention. The brake system for a hybrid electric vehicle of the present invention broadly comprises a regenerative braking system generating a regenerative braking force, a hydraulic braking system providing a hydraulic braking pressure to wheel cylinders 7 in which the hydraulic braking pressure might be supplied by an effort of a brake pedal 21 or hydraulic pump 35, and a control unit 50 controlling the regenerative braking system and the hydraulic braking system to generate a regenerative braking torque and a hydraulic braking torque to meet the target brake torque determined based on signals from pedal stroke sensor 41 and hydraulic pressure sensor 42 of a target braking force detection unit.

The regenerative braking system comprises a driving motor 15 controlled by a regenerative braking control unit 54 of the control unit 50 to generate the regenerative braking torque. At this time, the driving motor 15 is driven by electricity supplied from a battery 56 controlled by a battery control unit 55.

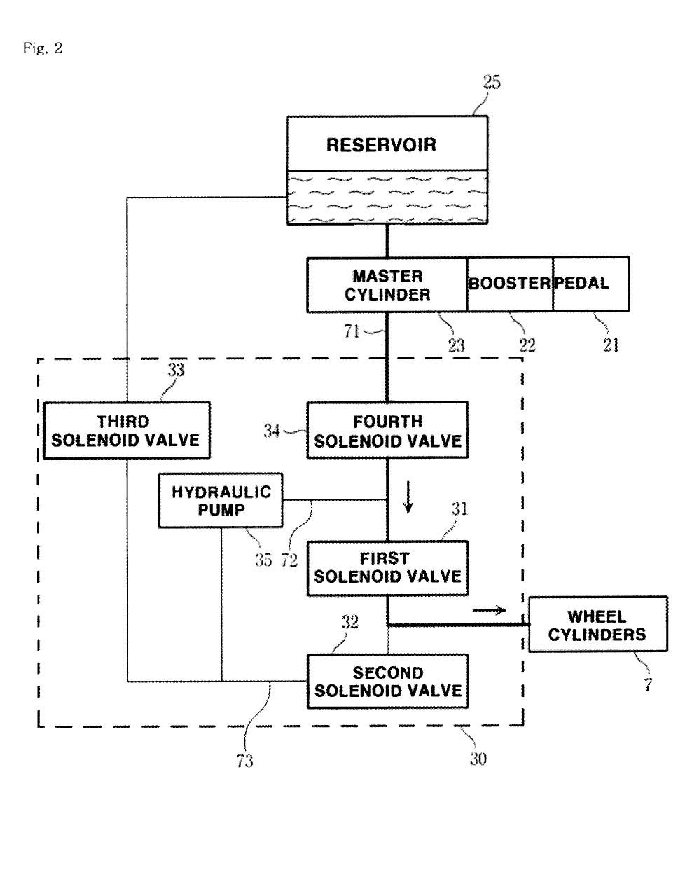

The hydraulic braking system comprises a hydraulic pressure supplying unit and a hydraulic brake adjuster. The hydraulic pressure supplying unit includes a booster 22 boosting the effort of the brake pedal 21, a master cylinder 23 generating a hydraulic pressure by the boosting force of the booster 22, a first hydraulic line 71 transmitting the hydraulic braking pressure generated in the master cylinder 23 to front and rear wheels 3 and 5 (see FIG. 2), a reservoir 25 mounted on the upper side of the master cylinder 23 and storing brake oil to be supplied to the first hydraulic line 71. The hydraulic brake adjuster 30 includes a first solenoid valve 31, a second solenoid valve 32, a third solenoid valve 33, a fourth solenoid valve 34, a hydraulic pump 35 for increasing or reducing the hydraulic braking pressure supplied from the reservoir 25 to the wheel cylinders 7, and a hydraulic pressure sensor 64 to detect the hydraulic pressure torque transmitted to the wheel cylinders 7.

Here, the increase or reduction in the hydraulic braking pressure is made by the regenerative braking torque varied in accordance with the output torque generated by the driving motor 15. That is, the control unit 50 detects a hydraulic braking torque transmitted to the wheel cylinders with a hydraulic pressure sensor 64 and monitors whether the system meets a condition that total braking torque defined as summation of hydraulic braking torque and maximum regenerative braking torque is equal to the target braking torque. As such, if the maximum regenerative braking torque generated by the driving motor 15 is so high that the total braking torque of hydraulic braking torque and maximum regenerative braking torque goes beyond the target braking torque, a hydraulic brake control unit 52 controls the hydraulic brake adjuster 30 to reduce the hydraulic braking torque so as to reduce the hydraulic braking pressure which is applied to wheel cylinders 7. On the other hand, if the maximum regenerative braking torque is so low that the total braking torque of hydraulic braking torque and maximum regenerative braking torque goes below the target braking torque, the hydraulic brake control unit 52 controls the hydraulic brake adjuster 30 to increase the hydraulic braking torque so as to increase the hydraulic braking pressure, thus providing a braking force desired by the driver.

As such, the present invention can realize a desired braking torque of the driver by changing the hydraulic braking torque in accordance with the regenerative braking torque varied according to the output torque generated by the driving motor 15.

Accordingly, the present invention has an advantage in that it is possible to meet a desired braking torque of the driver since the hydraulic braking system compensates an additional braking torque when an electric malfunction occurs, which makes the present invention distinct from the conventional EHB system in which the braking operation is made only by the regenerative braking torque and thereby it is impossible to obtain a desired braking torque during the electric malfunction.

To determine the braking torque desired by the driver, provided is a target braking force detection unit including a pedal stroke sensor 41 detecting a stroke of the brake pedal 21 and a hydraulic pressure sensor 42 detecting a hydraulic pressure of the master cylinder 23. The control unit 50 calculates a target braking torque based on the signals detected by the pedal stroke sensor 41 and the hydraulic pressure sensor 42.

The configuration of the hydraulic brake adjuster 30 will be described in more detail with reference to FIGS. 2 to 4. The hydraulic brake adjuster 30 comprises a hydraulic pump 35 for pumping brake oil of the reservoir 25, a first solenoid valve 31 selectively opening the first hydraulic line 71 connecting the master cylinder 23 or the second hydraulic line 72 connecting the hydraulic pump 35 when the hydraulic pump 35 is operated, and a second solenoid valve 32 selectively opening the oil passage from wheel cylinders 7 to third solenoid valve 33 which forms a third hydraulic line 73 between the wheel cylinders 7 and the reservoir 25 when the hydraulic pump 35 is stopped. Moreover, the third solenoid valve 33 of the hydraulic brake adjuster 30 is disposed between the second solenoid valve 32 and the reservoir 25, and the hydraulic brake adjuster 30 further comprises a fourth solenoid valve 34 disposed between the master cylinder 23 and the first solenoid valve 31.

FIG. 2 shows a case where a braking operation is made only by a hydraulic braking force when a regenerative braking torque is not generated because the battery 56 is at its maximum charge or because of a CAN communication error. In this case, the braking operation is made only by the hydraulic brake system. That is, if the driver presses the brake pedal 21, the brake oil in the reservoir 25 is supplied to the respective wheel cylinders 7 of the front and rear wheel sides 3 and 5 by way of the master cylinder 23, via the opened fourth solenoid valve 34 and the first solenoid valve 31 through the first hydraulic line 71, thus stopping the vehicle only by the hydraulic braking force applied by the driver. At this time, the first solenoid valve 31 and the fourth solenoid vale 34 are controlled by a solenoid valve driving unit 53 to be opened, and the second solenoid valve 32 and the third solenoid valve 33 provided in the third hydraulic line 73, through which the brake oil is returned to the reservoir 25, are controlled to be closed.

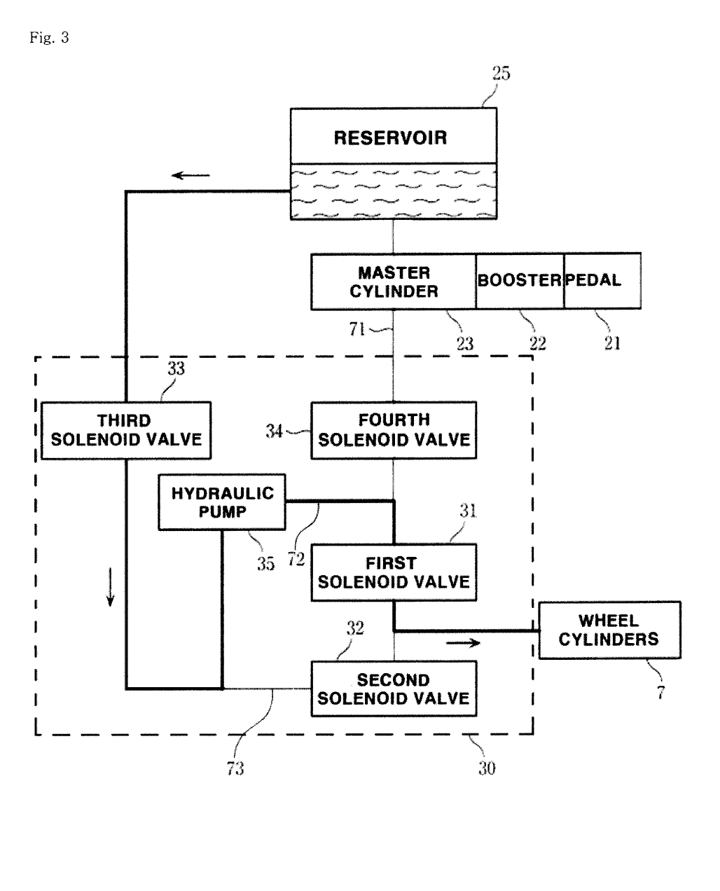

FIG. 3 is a configuration diagram illustrating a principle in which the hydraulic braking pressure to the wheel cylinders 7 is increased by hydraulic pump 35 when the maximum regenerative braking torque is so reduced in the brake system of FIG. 1, that the total braking torque of hydraulic braking torque and the maximum regenerative braking torque goes below the target braking torque.

If the regenerative braking torque maximum in accordance with the rotational speed of the driving motor 15, the state of charge of the battery 56, the vehicle state, etc. is reduced, the brake system is driven to increase the hydraulic braking torque so as to meet the target braking torque. In this case, a pump driving unit 51 drives the hydraulic pump 35 and the solenoid valve driving unit 53 opens the first solenoid valve 31 and the third solenoid valve 33 to form the second hydraulic line 72 to supply the brake oil in the reservoir 25 to increase the hydraulic braking pressure to the respective wheel cylinders 7. At this time, the solenoid valve driving unit 53 maintains the fourth solenoid valve 34 in the first hydraulic line 71 in a closed state. As such, it is possible to prevent the brake pedal 21 from depressing by transmitting the brake oil from the reservoir 25 directly to the wheel cylinders 7 not passing through the first hydraulic line 71 on the side of the master cylinder 23. Meanwhile, the solenoid valve driving unit 53 controls the second solenoid valve 32 in the third hydraulic line 73 to be closed so as not to divide the brake oil introduced through the second hydraulic line 72 to the third hydraulic line 73. This configuration helps to supply all the brake oil to the wheel cylinders 7, thus rapidly increasing the hydraulic pressure to the wheel cylinders 7.

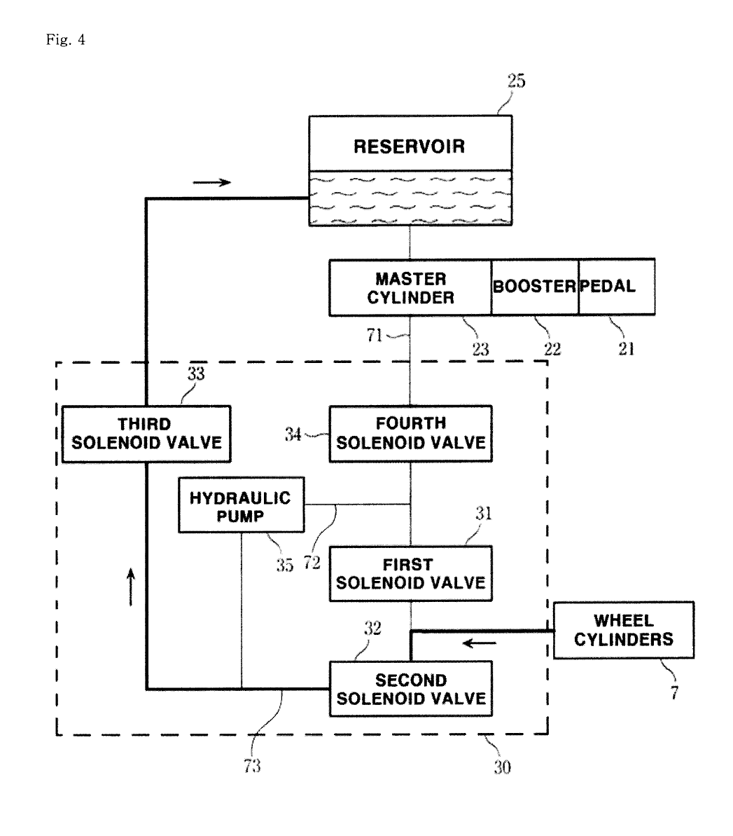

FIG. 4 is a configuration diagram illustrating a principle in which the hydraulic braking torque is reduced when the maximum regenerative braking torque so is increased in the brake system of FIG. 1 that the total braking torque of hydraulic braking torque and the maximum regenerative braking torque goes beyond the target braking torque.

If the regenerative braking torque maximum according to the rotational speed of the driving motor 15, the state of charge of the battery 56, the vehicle state, etc. is so increased that the total braking torque of hydraulic braking torque and the maximum regenerative braking torque goes beyond the target braking torque, the brake system is driven to reduce the hydraulic braking torque so as to meet the target braking torque. In this case, the pump driving unit 51 stops the hydraulic pump 35 and the solenoid valve driving unit 53 opens the second solenoid valve 32 and the third solenoid valve 33 to connect the third hydraulic line 73 to return the brake oil from the wheel cylinders 7 to the reservoir 25, thus reducing the hydraulic pressure in the wheel cylinders 7. At this time, the solenoid valve driving unit 53 maintains the first solenoid valve 31 in a closed state to prevent the hydraulic pressure in the master cylinder 23 from being decreased.

Moreover, it is desirable that the brake system should further include a booster negative pressure supplying unit 60 for supplying a negative pressure to the booster 22 (see FIG. 1). The booster 22 is connected to an intake manifold of an engine 45 and uses the negative pressure of the engine 45. Since the negative pressure is not generated in the engine 45 when the engine 45 is not operated, it is possible to generate a negative pressure in the booster 22 by means of a negative pressure supplying unit 60 in the hybrid electric vehicle. The booster negative pressure supplying unit 60 comprises a vacuum pressure sensor 61 detecting a negative pressure of the booster 22, and a vacuum pump 62 controlled by the pump driving unit 51 based on a signal of the vacuum pressure sensor 61. Accordingly, if the negative pressure of the booster 22 detected by the vacuum pressure sensor 61 is insufficient, the pump driving unit 51 drives the vacuum pump 62 to supply the negative pressure in the booster 22, thus making it possible to perform the braking operation smoothly.

Meanwhile, it is preferable that the booster negative pressure supplying unit 60 further include a vacuum tank 63 having a predetermined volume so as to prevent the negative pressure in the booster 22 from being rapidly reduced, if the driver presses the brake pedal 21 repeatedly. Therefore a vacuum tank 63 having a predetermined volume might provide the negative pressure to the booster 22 stably.

As described above, since the target braking torque calculated based on signals detected from the pedal stroke sensor 41 and the hydraulic pressure sensor 42 is compensated with an additional braking torque by variably adjusting the hydraulic braking torque based on the maximum regenerative braking torque varied according to the state of the driving motor 15 or the battery 56, it is possible to operate the hydraulic braking system adaptable to the desired target braking torque of the driver even under the circumstances that the regenerative braking torque is not generated due to errors occurring in the regenerative braking system, etc.

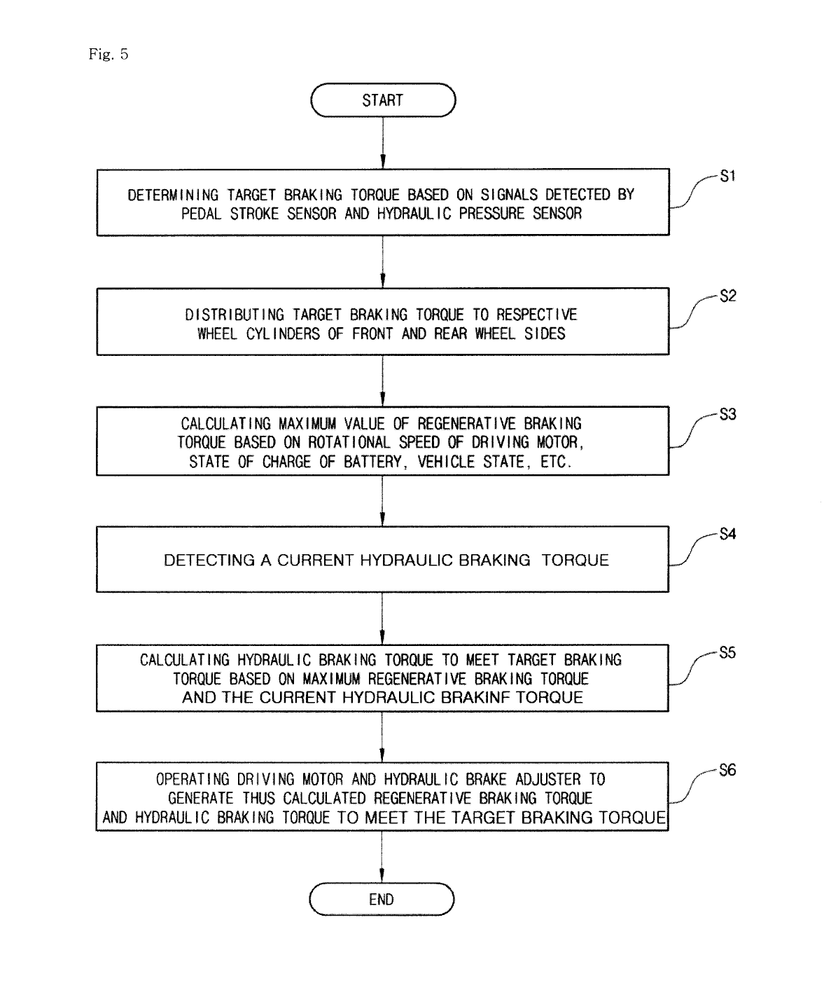

Turning now to a control method of the hydraulic braking system, a control method of the brake system for a hybrid electric vehicle configured as described above will be described with reference to FIG. 5.

First, a target braking torque desired by a driver is calculated based on signals detected by the pedal stroke sensor 41 and the hydraulic pressure sensor 42 at the step of S1, and the calculated target braking torque is distributed to the wheel cylinders 7 of the front and rear wheel sides 3 and 5 at the step of S2.

Thereafter, a maximum regenerative braking torque is calculated based on the rotational speed of the driving motor 15, the state of charge of the battery 56, the vehicle state, etc. at the step of S3, and a current hydraulic braking torque transmitted to wheel cylinders 7 is detected by a hydraulic pressure sensor 64 at the step of S4.

A hydraulic braking torque to meet the target braking torque is calculated based on the maximum regenerative braking torque and the current hydraulic braking torque at the step of S5.

Lastly, the driving motor 15 and the hydraulic brake adjuster 30 are driven to generate the regenerative braking torque and the hydraulic braking torque as much as the calculated amounts in the front and rear wheels 3 and 5, thus obtaining the desired braking force of the driver at the step of S6. Here, if the maximum value of the regenerative braking torque is reduced due to changes of various factors that determine the maximum regenerative braking torque, it is necessary to increase the hydraulic braking torque. At this time, the pump driving unit 51 drives the hydraulic pump 35 to supply the brake oil from the reservoir 25 to the wheel cylinders 7 along the second hydraulic line 72 so as to increase the hydraulic braking torque so as to increase the hydraulic braking pressure as shown in FIG. 3. Meanwhile, if the maximum regenerative braking torque is increased and thus total braking torque of hydraulic braking torque and maximum regenerative braking torque goes beyond the target braking torque, it is necessary to reduce the hydraulic braking torque to meet the target braking torque. In this case, the pump driving unit 51 stops the hydraulic pump 35 to return the brake oil from the wheel cylinders 7 to the reservoir 25 along the third hydraulic line 73 and thus decreases the hydraulic braking torque to adjust the total braking torque to the target braking torque as shown in FIG. 4.

As described above, the present invention provides a brake system for a hybrid electric vehicle and a control method thereof that can obtain a desired braking torque for the driver since the target braking torque calculated based on signals detected from the pedal stroke sensor and the hydraulic pressure sensor is tracked by variably adjusting the hydraulic braking torque based on the maximum regenerative braking torque varied in accordance with the state of the driving motor or the battery. In brief, it is possible to compensate an additional hydraulic braking torque of the hydraulic braking system, even under the circumstances that the regenerative braking torque is not generated or it is changed (increased or reduced) due to errors occurring in the regenerative braking system, etc.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A brake system for a hybrid electric vehicle comprising:
a driving motor generating a regenerative braking torque;
a hydraulic pressure supplying unit including a brake pedal, a booster and a master cylinder that increase an effort of the brake pedal, a first hydraulic line of front and rear wheel sides, and a reservoir storing brake oil to be supplied to the first hydraulic line;
a hydraulic brake adjuster for increasing or reducing hydraulic braking pressure supplied from the hydraulic pressure supplying unit to wheel cylinders;
a target braking force detection unit, including a pedal stroke sensor detecting a stroke of the brake pedal and a first hydraulic pressure sensor detecting hydraulic pressure of the master cylinder, for detecting a target braking torque of a driver; and
a control unit controlling the driving motor by calculating a maximum regenerative braking torque and controlling the hydraulic brake adjuster to change hydraulic braking torque to meet the target braking torque based on the thus calculated maximum regenerative braking torque.

2. The brake system of claim 1, wherein the control unit controls the driving motor by calculating the maximum regenerative braking torque in accordance with a rotational speed of the driving motor.

3. The brake system of claim 1, wherein the hydraulic brake adjuster includes a hydraulic pump for pumping the brake oil in the reservoir and a second hydraulic pressure sensor to detect a hydraulic braking torque transmitted to the wheel cylinders, and wherein the control unit drives the hydraulic pump to supply the brake oil in the reservoir to the wheel cylinders so as to increase the hydraulic braking torque, if a total braking torque of the hydraulic braking torque and the maximum regenerative braking torque goes below the target braking torque, and stops the hydraulic pump to return the brake oil in the wheel cylinders to the reservoir so as to reduce the hydraulic braking torque, if the total braking torque of the hydraulic braking torque and the maximum regenerative braking torque goes beyond the target braking torque.

4. The brake system of claim 3, wherein the hydraulic brake adjuster further includes a first solenoid valve, a second solenoid valve and a third solenoid valve, and wherein the control unit opens the first solenoid valve and the third solenoid valve to form a second hydraulic line between the reservoir and the wheel cylinders when the hydraulic pump is operated, and opens the second solenoid valve and the third solenoid valve to form a third hydraulic line so as to decrease the hydraulic braking pressures of the wheel cylinders.

5. The brake system of claim 1 further comprising a booster negative pressure supplying unit for supplying a negative pressure to the booster when an engine is not operated.

6. The brake system of claim 5, wherein the booster negative pressure supplying unit includes a vacuum pressure sensor detecting vacuum pressure of the booster and a vacuum pump controlled by the control unit based on a signal of the vacuum pressure sensor.

7. The brake system of claim 6, wherein the booster negative pressure supplying unit further includes a vacuum tank having a predetermined volume to prevent negative pressure in the booster from being rapidly reduced during repeated braking operation.

8. A control method of a brake system for a hybrid electric vehicle comprising the steps of:
determining a target braking torque based on signals detected by a pedal stroke sensor and a hydraulic pressure sensor;
distributing the target braking torque to respective wheel cylinders of front and rear wheel sides;
calculating a maximum regenerative braking torque;
determining a current hydraulic braking torque;
calculating a hydraulic braking torque to meet the target braking torque based on the maximum regenerative braking torque and the current hydraulic braking torque; and
driving a driving motor and a hydraulic brake adjuster, respectively, to generate the thus calculated maximum regenerative braking torque and hydraulic braking torque.

9. The control method of claim 8, wherein calculating the maximum regenerative braking torque is based on a rotational speed of a driving motor, a state of charge of a battery and a vehicle state.

10. The control method of claim 8 further comprising the step of driving a hydraulic pump of the hydraulic brake adjuster to supply brake oil from a reservoir to the wheel cylinders, thus increasing the hydraulic braking torque, if a total braking torque of the hydraulic braking torque and the maximum regenerative braking torque goes below the target braking torque.

11. The control method of claim 8 further comprising the step of stopping the hydraulic pump of the hydraulic brake adjuster to return the brake oil from the wheel cylinders to the reservoir, thus reducing the hydraulic braking torque, if a total braking torque of the hydraulic braking torque and the maximum regenerative braking torque goes beyond the target braking torque.
